(19) United States
(12) Patent Application Publication
(10) Pub. No.: US 2002/0129553 A1
(43) Pub. Date: Sep. 19, 2002

(54) Louvre system

(75) Inventors: Paul Peter Metzen, Mayfield East (AU); Sigfried Umlauf, Avalon Beach (AU)

Correspondence Address: OLIFF & BERRIDGE, PLC, P.O. BOX 19928, ALEXANDRIA, VA, 22320, US

(73) Assignee: PIPIDOL PTY LIMITED, Sydney (AU)

(21) Appl. No.: 09/993,560

(22) Filed: Nov. 27, 2001

Related U.S. Application Data
(63) Continuation-in-part of application No. PCT/AU00/00628, filed on Jun. 5, 2000.

(30) Foreign Application Priority Data
Jun. 4, 1999 (AU) PQ 0782

(51) Int. Cl. E06B 7/096

(52) U.S. Cl. 49/82.1; 49/74.1; 49/89.1

(57) ABSTRACT

A louvre system is disclosed which includes a frame having spaced apart side frame members (13, 14). A plurality of louvre blades are disposed between, and mounted to the side frame members (13, 14) so as to be rotatable about an axis of rotation. One of the frame members (14) includes a drive arrangement (21) which includes a plurality of gears (28) mounted on a subframe and connected to respective louvre blades. The gears are driven by a timing belt under the drive of a manual or electric actuator, to impart synchronised movement to the louvre blades.

### TECHNICAL FIELD

The present invention relates to a louvre system. The invention has been designed especially, but not exclusively for use as a louvre shuttering for windows and doors and the like and the invention is herein described in that context. However, it is to be appreciated that the invention has broader application and may be used in other louvre arrangements.

### BACKGROUND

Louvre shutters generally comprise an external frame in which a plurality of louvre blades are incorporated. These blades may be fixed to the frame but often are rotatable within the frame so as to be able to move into different orientations to vary the amount of space between adjacent blades. The advantage of louvre shuttering systems over solid shutters is that they can keep out direct sunlight or aid privacy while still allowing airflow through the shutter. The use of the rotatable louvre blades has a further advantage that the exact position of the louvre blades can be manually controlled so that a desired gap between the blades is obtained to suit the needs for privacy, ventilation, sunshade or the like.

In shuttering systems which incorporate movable louvre blades, a drive mechanism is provided so as to be able to synchronise the movement of the individual blades. Typically the blades are elongate and relatively thin, having the general profile similar to that of an aerofoil, and the blades move in unison from a position wherein they extend outwardly, thereby providing the maximum gap between adjacent blades, to a position where they fold downwardly into general abutting relationship so as to provide a substantially closed face.

In the past, a drive arrangement including a bar connected to the leading edge of the individual louvres has been used. The bar is moved under a manual force either through direct contact with the bar or alteratively through a lever connected to the bar via a linkage mechanism. When the shutter is closed, the bar folds against the shutter frame. When the shutter is in a fully open position, the bar is displaced outwardly from the frame.

Whilst the above drive arrangement is adequate in providing synchronised movement of the louvre blades, there are distinct shortcomings. In particular, as the bar is directly coupled to the louvre blades, the amount of movement of the blades is restricted. Further a space is usually provided within the frame to accommodate the bar when a shutter is in its closed position. When moved from its closed position, a gap is formed between the frame and the respective louvre blades. This gap substantially reduce the performance of the shutter in aiding privacy and shielding sunlight.

### SUMMARY OF THE INVENTION

An aim of the present invention is to provide a louvre system of the type which incorporates movable louvre blades which has an improved drive arrangement. A further aim of the arrangement is to provide a louvre system that is simple to manufacture and has improved performance over existing systems.

In a first aspect, the present invention provides a louvre system including a frame having opposite spaced apart first and second side frame members, each of the side frame members extending in a longitudinal direction between opposite first and second ends, a plurality of louvre blades disposed between, and mounted to, said side frame members, each of the blades having an axis of rotation which is transverse to the longitudinal direction of each of the side frame members, wherein one of said side frame members includes a cavity and the louvre system includes a drive arrangement disposed within the cavity, the dive arrangement being connected to the louvre blades and operative to drive the louvre blades in a synchronised movement.

An advantage of the present invention is that by concealing the drive member within the frame the louvre blades can be better fitted within the louvre system frame as there is no requirement to accommodate the external drive arrangement as in previous systems. This not only improves the aesthetic appeal of the shuttering system but can substantially improve its performance as the blades can fit wholly within the frame thereby eliminating any gaps. Further, by incorporating the drive arrangement within the frame, the angle of movement of the blades can be much less restricted than these previous systems.

In a preferred form, the drive arrangement incorporates coupling elements which are operative to be coupled to the individual louvre blades. The coupling elements are preferably in the form of drive shafts which project from the louvre blade into the frame and have the dual function of not only providing drive to the louvre blades but also to support the louvre blades correctly in position within the frame.

In a preferred form, the drive arrangement further includes a plurality of gears which are associated with respective ones of the coupling elements, and at least one connecting element operative to transmit drive to the individual gears so as to provide the synchronised movement to the individual gears. The connecting element may be in the form of a flexible member such as belt, chain or rope, or a rigid member may be used such as a toothed rack, gear, camshaft or the like.

For ease of manufacture, preferably each drive shaft is integrally formed with, or rigidly connected to one of either a respective one of the gears or the louvre blades and is releasably connected to the other of the blades or gears. To maintain synchronised movement between the drive arrangement and the blade preferably relative rotation between the gear and blade is inhibited. In a preferred form, this relative rotation is restricted by keying the drive shaft into engagement with the gear or louvre blade to which it is releasably coupled.

In a preferred form, a toothed timing belt is used as the connecting element. In this arrangement, each gear incorporates a plurality of teeth disposed along its periphery which engage with the teeth of the belt. The advantage of using a timing belt is that it is compact, does not resist the amount that the blades can rotate and there is very little potential for slip between the belt and the gears which could cause the louvre blades to move out of alignment.

Actuation of the drive arrangement may either be by manual operation or may be motorised. In one form, an electric motor is coupled to a gear within the drive arrangement. The motor is designed to rotate that gear and this movement is imparted to the other gears by the belt. In another form, one of the gears is coupled typically by a gearing system to an externally mounted louvre control which is manually operable. Similar to the motorised version, actuation of the louvre control induces rotation to the gear to which it is connected which in turn is imparted to the other gears via the belt.

In a particularly preferred form, the gears are mounted on a subframe to form a gear block. The gear block in turn is mounted to the frame member. This arrangement has substantial practical benefit in that it can greatly simplify the construction of the louvre system. The gear block can be supplied as a single component which is then fitted directly into the frame. This obviates the need for individual installation of the gears to the frame and ensures that the connect spacings between the gears is maintained.

In a particularly preferred form, the drive shafts of the drive arrangement are formed with the gears and extend from the gear block. Further the one frame member is channel shaped and includes a web and opposing flanges. The gear block is arranged to be coupled to respective flanges preferably in a manner which locks the subframe to the one frame member.

Preferably, the other side frame member is similarly constructed with the exception that the subframe which interfits with that frame member carries spigots which support the opposite end of the louvre blades in a manner that does not inhibit rotation of the blades.

By virtue of the novel drive arrangement, the louvre system according to a preferred form of the invention is easy to manufacture yet provides enhanced performance. The system allows for closer fitting of the louvre blades to the frame, whilst allowing a greater degree of freedom of movement of the blades. The drive arrangement also ensures accurate controlled movement of the louvre blades and the option for motorised actuation.

A further advantage of the louvre of a preferred form of present invention is that it allows for ease of transporting and assembly on site. In this regard, the frame members can be transported in a disassembled state with the one side frame member fully encasing the drive arrangement. The louvre blades can also be easily packed for transit. On site, the system can easily be assembled by locating of the blades onto the drive shaft and support spigots which protrude from the side frame members and the bottom and top frames fastened in places to secure the structure together.

In yet a further aspect, the present invention provides a frame system for use in a louvre system, said frame system including a frame member extending in a longitudinal direction between opposite first and second ends and including a cavity extending between said ends, and a drive arrangement disposed within said cavity in said frame member, said drive arrangement including a plurality of coupling elements spaced along said member in said longitudinal direction, said coupling elements being operative to be connected to louvre blades, and wherein said drive arrangement is operative to move said louvre blades when so connected in a synchronised movement.

### BRIEF DESCRIPTION OF THE DRAWINGS

It is convenient to hereinafter describe embodiments of the present invention with reference to the accompanying drawings. It is to be appreciated that the particularity of the drawings and the related description is to be understood as not superseding the broad description of the invention.

In the drawings;

FIG. 1 is a front elevation of a louvre shutter according to an embodiment of the invention;

FIG. 2 is a sectional side view along section line II-II of the shutter of FIG. 1;

FIG. 3 is a sectional plan view to an enlarged scale along section line III-III of the shutter of FIG. 1;

FIG. 4 is an elevation view of the gear block used in the drive arrangement of the shutter of FIG. 1;

FIG. 5 is a cross sectional view along section line V-V of the gear block of FIG. 4;

FIG. 6 is a detailed view of the subframe of the gear block of FIG. 4;

FIG. 7 is a detailed view of the drive arrangement coupled to an actuator motor within the frame of the shutter of FIG. 1.

FIG. 8 is a cross-section view illustrating an alternative louvre shutter incorporating a plurality of mullions;

FIGS. 9(a) to 9(c) illustrate various transom options that may be used in the louvre shutter;

FIG. 10 is a detailed view illustrating an alternative method of securing the timing belt in place in the drive arrangement of the louvre shutter;

FIG. 11 is a section view illustrating a manual actuator for the louvre shutter;

FIG. 12 is a cross-sectional view along section line XII-XII of FIG. 11;

FIG. 13 is a section view illustrating alternative arrangement for the connection of motor drive to the drive arrangement;

FIG. 14 is a cross-sectional view along section lines XIV-XIV of FIG. 13;

FIG. 15 illustrates a louvre shutter in a knock down state;

FIG. 16 is a detailed schematic view illustrating the connections of the mullions to the bottom frame of the louvre shutter;

FIG. 17 is an alternative manual actuator for the louvre shutter;

FIG. 18 is a section view of the gear block incorporating a rotation control system;

FIG. 19 is a section view of the gear used in the rotation control system illustrated in FIG. 18;

FIG. 20 is a sectional view along section line XX-XX of FIG. 18; and

FIG. 21 illustrates the gear block of FIG. 20 incorporating an insert to limit the rotation of the louvre blades.

### DETAILED DESCRIPTION

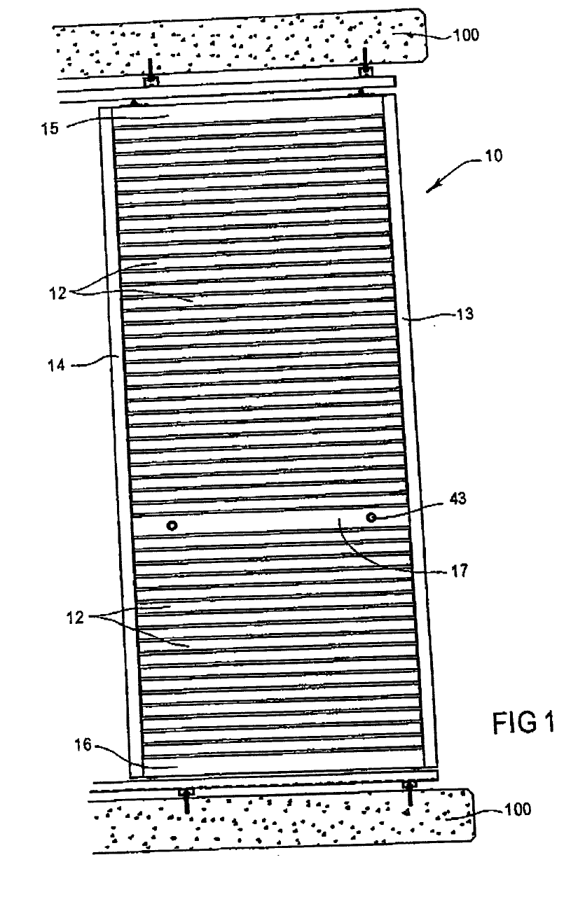

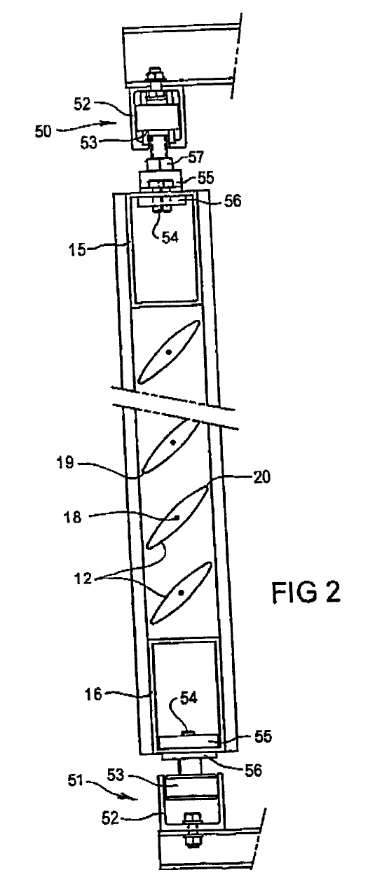

Turning firstly to FIGS. 1 and 2, a louvre shutter 10 is disclosed which includes a frame 11 and a plurality of louvre blades 12. The frame includes a pair of vertical side frame members 13, 14, which are interconnected by top and bottom frame members (15 and 16 respectively) and a transom 17.

The blades 12 are elongate and have a cross sectional profile similar to that of an aerofoil (as best illustrated in FIG. 2). The blades 12 are mounted to the side frame members 13 and 14 so as to be pivotable about an axis of rotation 18. In this way, the blades are movable from a fully opened position where the leading and trailing edges (19 and 20) of the respective blades are generally horizontal so as to maximise the spacing between adjacent blades 12, to a fully closed position where adjacent blades are in abutting relationship with the leading edge 19 of one blade in contact with the trailing edge 20 of an adjacent blade.

In the illustrated arrangement, the shutter 10 is slidably mounted to an external structure 100. This is best illustrated with reference to FIG. 2. It is to be appreciated however that the shutter 10 of the invention is not limited to any specific configuration or mode of connection to an external structure. In this respect, the shutter 10 may be used in other orientations than a vertical orientation as illustrated, and may be fixed or movable.

In the present arrangement, the shutter 10 is connected to the external structure 100 by upper and lower track assemblies 50 and 51. Each track assembly includes a track rail 52 which is secured to the external structure, and a runner 53 which is mounted to the respective upper and lower frames (15, 16). Each runner 53 includes a portion which projects outwardly from the frame with the upper runner arranged to be captured within its associated track 52 and slidable therein. In this way, the upper track assembly 50 supports the weight of the shutter 10. The lower track assembly primarily acts as a guide to maintain the shutter in vertical alignment with the lower runner 53 being freely located with the lower rail 52.

In the illustrated form of FIG. 2, each of the upper and lower frame members (15,16) is formed as box sections and whilst not shown, typically includes a recess in its outer end surface to allow installation and securing of the runners 53. In the illustrated form, the runners 53 are secured in place by a threaded stud 54 and nut 57 which is operable to clamp two opposing flanges 55, 56 to the respective frame members 15, 16.

The movement of the louvre blades 12 is controlled by a drive arrangement 21 which is installed in a cavity 22 formed within the side frame member 14. This is best illustrated in FIGS. 3 to 7.

Turning firstly to FIG. 3, the louvre blades are each connected to the side frames 13 and 14 by shafts 23, 24 which are mounted along the axis of rotation 1B of the respective blades 12. Both shafts 23,24 are designed to rotate with the blade 12 and incorporate keyways 25 so as to key the shafts into engagement with the blade so as to prevent relative slipping of the shafts within the blade 12. With this arrangement the outer ends of the blades 12 are in close fit arrangement with the respective side frame members 13 and 14.

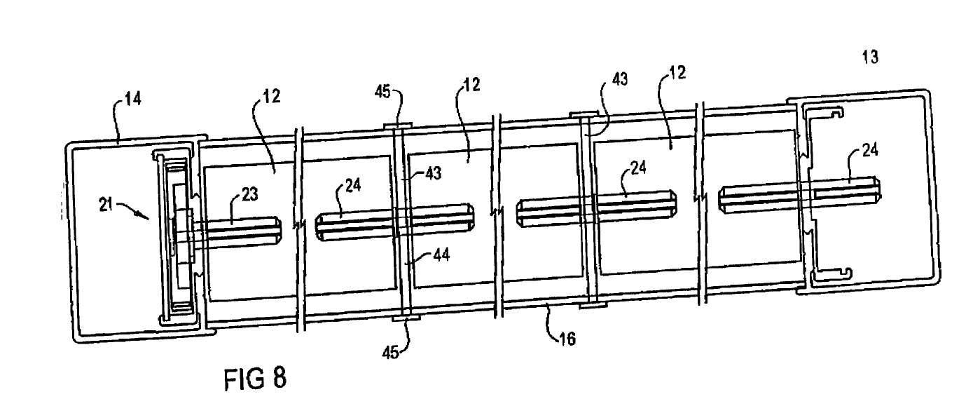

The shaft 23 forms part of the drive arrangement 21 as will be discussed in more detail below whereas the shaft 24 is passive in that it is not directly driven and its primary function is to support one end of the blade 12. In the illustrated arrangement, the shaft 24 includes a tail portion 26 which projects into the cavity 27 of the side frame member 13. The tail portion 26 of the shaft 24 is configured to accommodate and support one end of a further louvre blade (see FIG. 8) should an additional set of louvre blades to produce a wider shutter be required. In this arrangement, one or more mullions 43 are provided between the louvre blades and the side frame 13 in turn is coupled to the other end of the additional set of louvre blades.

Turning to FIG. 8, the mullions 43 are formed as a shallow I section having a central web 44 and end flanges 45 and extend between the top and bottom frame members (15, 16). FIG. 16 illustrates the connection of a mullion to the bottom frame member 16. The member 16 shown in FIG. 16 is a modified version to that described in FIGS. 1 and 2 but provides the same basic function and includes a raised portion 46 which has an extruded slot 47 operative to receive a fastener 58. A lateral groove 49 is formed in the raised portion 46 to receive the web 44 of the mullion 43. Once in place, the fastener is positioned in the slot 47 and extends through an aperture 59 formed in the mullion web 44 to secure the mullion to the frame member. A similar coupling arrangement may be used for the upper frame member 15.

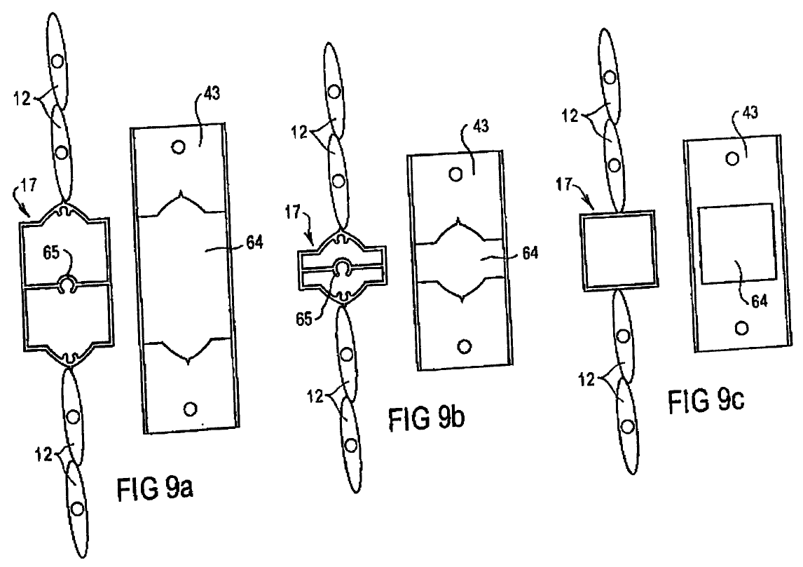

FIGS. 9(a) to 9(c) illustrate various designs of transom 17 that may be used in the shutter 10. These vary from larger sections shown in FIG. 9(a) to smaller simpler versions shown in FIG. 9(c). The choice of section depends on the structural properties required as well as on aesthetic appeal. In each case the transom is designed to extend through a passage 64 formed in any mullion 43 which is incorporated in the shutter 20. These passages 64 are cut during manufacture to ensure the required accuracy is obtained. To facilitate their connections to the side frames, the transoms may be formed as extruded sections having a slot 65 which may be threaded to receiving a stud, or other fastener (not shown) to fasten the transom to the side frames. Such an arrangement is disclosed in FIGS. 9(a) and 9(b).

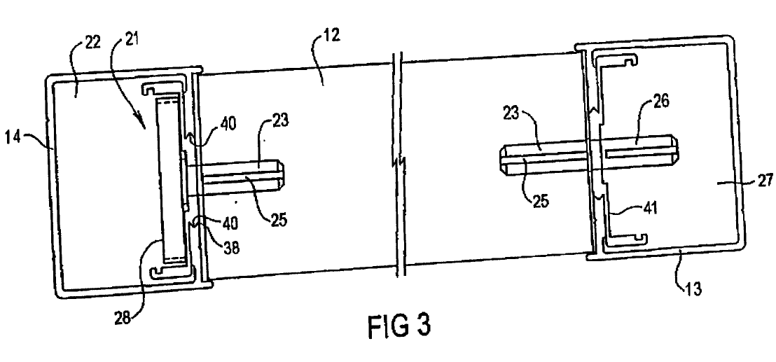

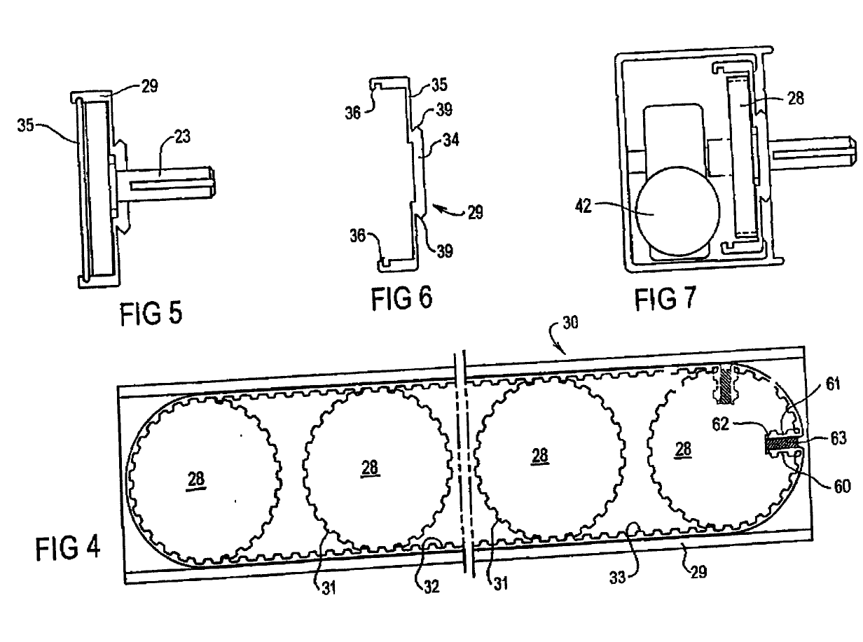

Each of the shafts 23 forms part of the drive arrangement 21, and is connected to individual gears 28 which are mounted within a subframe 29 as best illustrated in FIG. 4 so as to form a gear block 30. The subframe 29 is formed as an elongate section as best illustrated in FIG. 6 and the gears 28 are mounted to the frame 29 at predetermined spacings along its length. These spacings correlate with the required spacing for the individual louvre blade 12 in the shutter 10. The individual gears 28 include teeth 31 on their outer surface and are arranged to be driven by a timing belt 32 which includes teeth 33 which co-operate with the teeth 31 on the gears 28. This arrangement enables the individual gears 28 within the block to be synchronised in their movement.

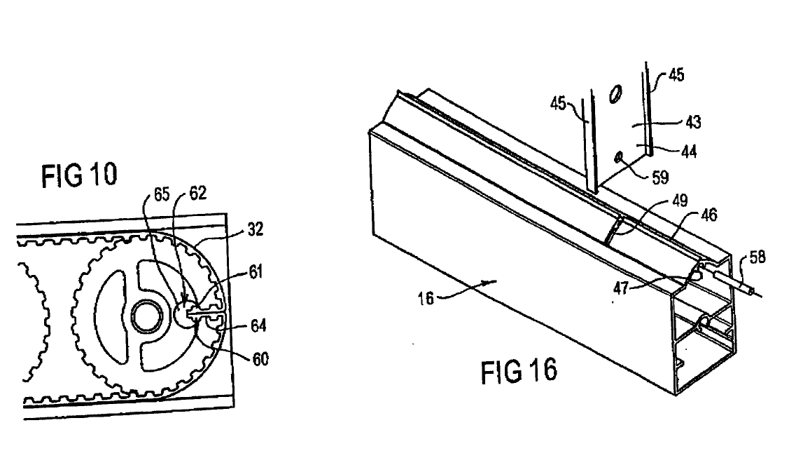

In the embodiment illustrated in FIG. 4, the ends (60, 61) of the timing belt 32 are captured within a complementary shaped slot 62 formed on one of the gears 28. A block 63 is used to secure the ends 60, 61 in place. An alternative form is illustrated in FIG. 10, where the slot 62 formed in the gear 28 is shaped as a keyway having a waisted section 64 and an enlarged head 65. One tooth spaced from each outer edge of the belts ends 60, 61 is removed to enable the ends to be laterally located with the keyway to be secured in place. In both arrangements, no separate fasteners are required to secure the individual ends 60,61 of the belt 32 in place.

The subframe 29 is formed typically as an extruded section and incorporates a raised portion 34 on its front face 35. Grooves 36 are located at the rear surface of the frame 29 to accommodate a back cover plate 37 as illustrated in FIG. 5. In this way the gear block 30 forms a closed housing encasing the gears 28 and belt 32.

The gear block 30 is arranged to be mounted within the side frame 14. To secure the gear block in place, and to allow the active drive shafts 23 to project from the side frame 14 so as to be in a position to engage with the louvre blades 12, the side frame 14 is channel shaped and includes a longitudinal aperture 38. This aperture is dimensioned so that the raised portion 34 of the subframe 29 is locatable within the aperture 36 so as to be in a tight fitting engagement with the side frame 14. To produce this tight fitting engagements the longitudinal edges 39 of the raised portion 34 of the sub-frame taper outwardly and locate within notches 40 formed along the edge of the side frame 14 which bound the aperture 36.

In installing the gear block 30 within the side frame 14, the frame is initially expanded by use of an air pillow or the like which is inserted within the cavity 22. The gear block 29 is then slid into position from one end of the side frame 14 so that the raised portion 34 locates within the groove 38. Once installed, the air pillow is removed from the cavity 22 of the side frame 14 thereby causing the frame to return to its natural state which causes it to clamp to the gear block 30. In this way, no separate fasteners are required to secure the gear block in place.

The side frame 13 includes the same cross section profile as the frame member 14 and a same system is used to secure the passive shafts 24 in place. Specifically, shafts 24 are mounted to a subframe 41 which has the same profile as subframe 29. The frame member 13 is similarly expanded to install the subframe 41 and then released to clamp the frame 41 in place.

Actuation of the drive arrangement 21 may be either by manual operation or by a motorised drive. As illustrated in FIG. 7, an electric motor 42 may be incorporated within the cavity 22 of the side frame 14 and be directly coupled to one of the gears 28. In this way, the motor can impart drive to the gear 28 to which it is connected, and this movement is imparted to the other gears by the timing belt 32. An actuation control 42 is provided on the exterior such as on the transom 17 as illustrated in FIG. 1.

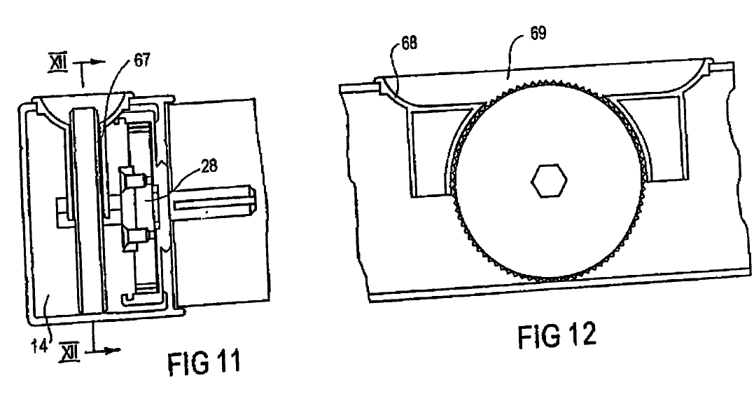

FIGS. 11 and 12 illustrate a manual control 66 which is mounted in the side frame 14. The manual control 66 includes a rotatable actuator 67 which is directly coupled to a gear 28 of the drive arrangement 21. The actuator is mounted within the side frame 14. A coverplate 68 is located within a cutout section formed in the side frame 14. The coverplate 68 locates over the actuator 67 and provides a recess 69 which enables easy access to a periphery 70 of the actuator 67. The periphery 70 is knurled to provide a high friction surface to facilitate manual control of the louvre.

FIG. 17 illustrates a further arrangement for a manual control 66. In this form the control 66 is designed to be installed through a wall or the like so that the actuator 68 is remote from the actual louvre shutter 10. The control includes a bevel gear arrangement 70 which is coupled to one of the gears 28 of the drive arrangement 21. A flexible drive rod 81 is connected to the gear arrangement 80 and extends from the louvre frame 14. The rod 81 is connected at its distal end 82 to the actuator 68. In this arrangement rotation of the actuator 68 is imparted through the drive rod 81 to the gear arrangement 80 and then to the gear 28 to drive the drive arrangement 21. The flexible rod 81 enables the actuator to be remote from the shutter 10 and is ideally suited to extend through walls or the like.

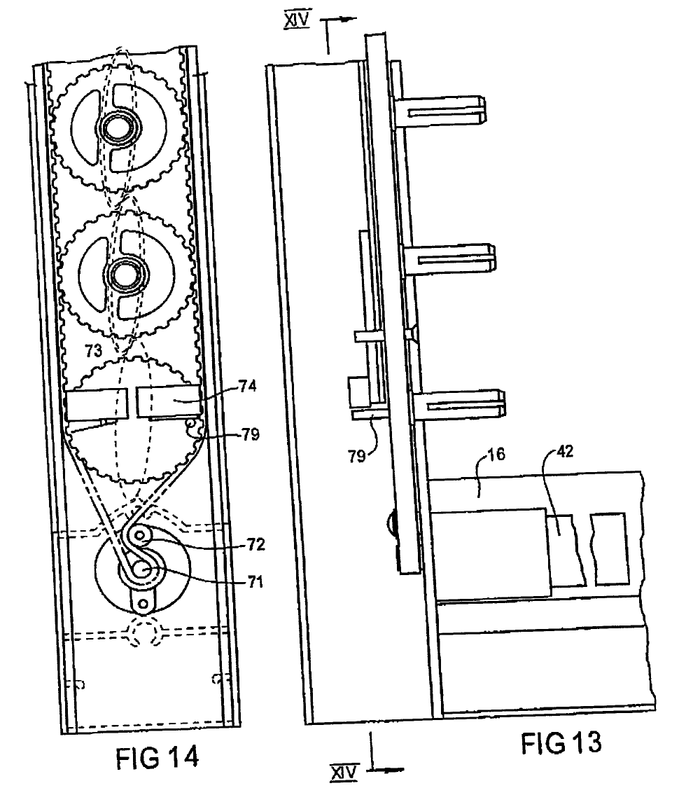

FIGS. 13 and 14 illustrate a variation in the mounting of a motor drive in the louvre shutter. In this embodiment, the bottom frame member is configured to house the electric motor 42. The motor drive shaft 71 extends into the side frame 14 where it is connected to the timing belt 32. A tension device 72 is incorporated to ensure adequate tension in the belt 32. To limit operation of the electric motor 42, microswitches 73, 74 are arranged to engage a pin 79 connected to the lowermost gear 28 which are caused to deactivate the motor when the gear 28 rotates through a predetermined angular displacement. This angular displacement corresponds to the full degree of travel permitted by the louvres.

Under operation of the actuation system the louvres are able to rotate in a synchronised movement under the drive arrangement Typically the louvre blade will be moveable in the vicinity of 175°. However, if necessary the degree of movement may be easily controlled. In some instances to protect the privacy of occupants of adjacent properties, some councils may restrict the degree of movement. This requirement may be easily implemented into the louvre shutter by incorporating stops into the drive arrangement to limit the degree of rotation of one of the gears.

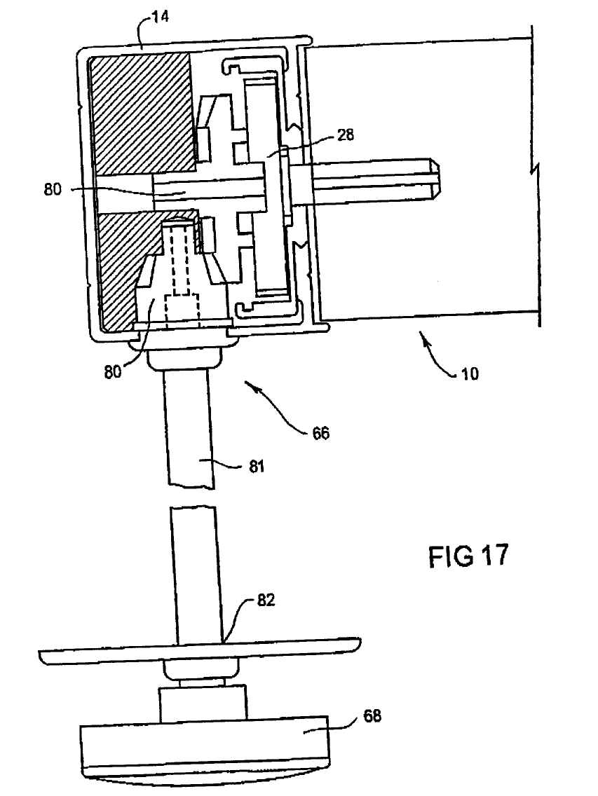

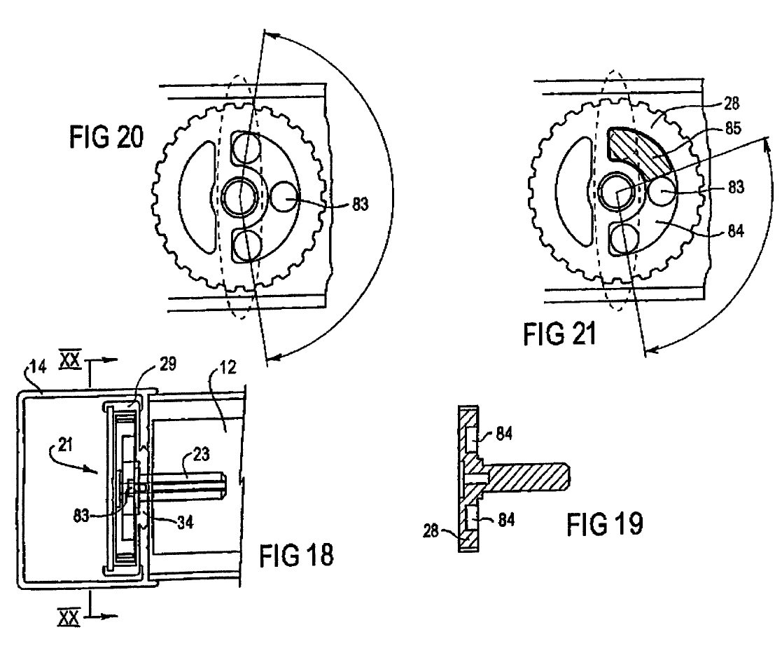

FIGS. 18 to 20 illustrate an embodiment of the louvre shutter which incorporates a stop 83 to control the degree of rotation of the louvre blades.

As best illustrated in FIG. 18, the stop 83 which is in the form of a stainless steel cap stud is secured to the subframe 29 by being tapped into the raised portion 34, offset from the axis of rotation of one of the gears 28. A gear 28 is operative to engage the stop and includes an arcuate groove 84 as best illustrated in FIGS. 19 and 20. The stop 83 is designed to extend into the groove 84 and controls the amount of free rotation of the gear 28 relative to the subframe.

To further limit the amount of rotation of the louvre blades, an insert 85 may be fitted into the groove to restrict the amount of travel allowed by the stop in groove 84. Such an arrangement is illustrated in FIG. 21.

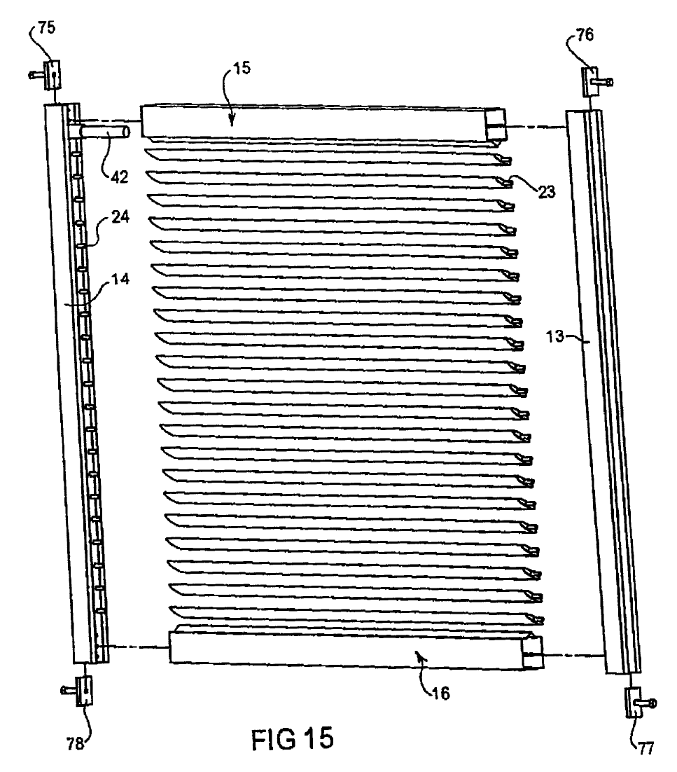

FIG. 15 shows the louvre shutter in a knockdown state. As can be seen the shutter may be transported in a disassembled form and easily installed on site. In its disassembled form, the side frame 14 can be transported as a single unit fully containing the drive arrangement 21 with the exception of the motor 42, which is typically transported separately. Also the louvres 12 can be easily packed together as a set.

On site the individual frame components (13, 14, 15, 16) are simply secured together by only a few fasteners (75, 76, 77, 78) and the louvres connected to the side frames merely by slotting into the shafts 23 protruding from the side frame 14 and the shafts 24 locating into the preformed holes in the subframe of the other side member 13. A guide block (not shown) which includes a plurality of aligned slots operative to receive respective louvre blades may be used to easily align each of the louvre blades.

Typically the frame members and subframe of the shuttering system 10 are formed as metal extrusions although some components, particularly the subframe may be formed from plastic. The gears 28 and active drive shaft 23 are typically integrally formed from a single moulding and may be formed of plastics or nylon or composite material or the like.

With this arrangement, the shuttering system is ideally suited for mass production and assembly of the componentary to make up the shutter is greatly simplified over previous systems as very few individual fasteners are required. Accordingly, the louvre system 10 of the present invention is easy to manufacture, and provides improved performance over previous systems.

Finally, it is to be appreciated that various alterations or modifications may be made to the parts previously deemed without departing from the spirit or ambit of the invention.

1. A louvre system including a frame having opposite spaced apart first and second side frame members, each of the side frame members extending in a longitudinal direction between opposite first and second ends, a plurality of louvre blades disposed between, and mounted to, said side frame members, each of the blades having an axis of rotation which is transverse to the longitudinal direction of each of the side frame members, wherein one of said side frame members includes a cavity and the louvre system includes a drive arrangement disposed within the cavity, the drive arrangement being connected to the louvre blades and operative to drive the louvre blades in a synchronised movement

2. A louvre system according to claim 1, wherein the drive arrangement incorporates drive shafts which are coupled to the individual louvre blades, the drive shafts projecting from the louvre blades into the one side frame member.

3. A louvre system according to claim 2, wherein the drive arrangement further includes a plurality of gears associated with respective ones of said drive shafts, and at least one connecting element interconnecting the gears so that the drive arrangement is operative to transmit drive to the individual gears through the connecting element so as to provide synchronised movement of the individual drive shafts.

4. A louvre system according to claim 3, wherein each of the drive shafts is integrally formed with, or rigidly connected to, one of either the respective gears or louvre blades and is releasably connected to the other of said blades or gears.

5. A louvre system according to claim 4, wherein the gears include a plurality of teeth disposed along their respective outer periphery and the connecting element is a timing belt which is operative to engage the teeth of the individual gears so as to drive the gears in the synchronised movement.

6. A louvre system according to any one of claims 3 to 5, wherein the gears are mounted on subframe to form a gear block, said sub frame determining the spacing between the individual gears and wherein said gear block is operative to be connected to said one side frame member.

7. A louvre system according to claim 6, wherein said one side frame member is generally channel shaped having a web member and opposing flanges which extend outwardly from sold web member, wherein said sub frame is operative to engage said opposing flanges to connect to said one side frame member.

8. A louvre system according to claim 7, wherein said sub frame includes opposite edges which interfit with edge surfaces of said respective flanges to lock said sub frame to said one side frame member.

9. A louvre system according to claim 8, wherein said sub frame includes a main housing which includes said gears and an outer raised portion which includes said opposite edges which interfit with said flanges of said one frame member.

10. A louvre system according to any one of claims 6 to 9, wherein said drive shafts are connected to said gears and project outwardly from said sub frame.

11. A louvre system according to any one of claims 3 to 10, wherein the drive arrangement further includes an actuator operative to drive the individual louvre blades in the synchronised movement.

12. A louvre system according to claim 11, wherein the actuator includes a louvre control which is coupled to one of said gears, and manually operable to drive said louvre blades in said synchronised movement.

13. A louvre system according to claim 12, wherein the actuator is in the form of a rotatable wheel which is mounted in one of said side frame members.

14. A louvre system according to claim 12, wherein the actuator is in the form of a manually operable control which is mounted remote from said louvre frame and connected to said one gear through a drive member.

15. A louvre system according to claim 11, wherein the actuator is in the form of an electric motor which is coupled to one of said gears so as to be operative to drive said louvre blades in said synchronised movement.

16. A louvre system according to any one of claims 3 to 15, wherein said drive arrangement is operative to limit the degree of rotation of the louvre blades.

17. A louvre system according to claim 16, further including a stop fixed relative to said one side frame member which is operative to be received in an arcuate slot formed in one of said gears so as to limit the degree of rotation of that gear.

18. A louvre system according to claim 17, further including at least one insert which is operative to be fitted into said arcuate slot so as to restrict the degree rotation of the gear.

19. A frame system for use in a louvre system, said frame system including a frame member extending in a longitudinal direction between opposite first and second ends and including a cavity extending between said ends, and a drive arrangement disposed within said cavity in said frame member, said drive arrangement including a plurality of coupling elements spaced along said member in said longitudinal direction, said coupling elements being operative to be connected to louvre blades, and wherein said drive arrangement is operative to move said louvre blades when so connected in a synchronised movement.

20. A frame system according to claim 19, wherein the drive arrangement includes a plurality of gears associated with respective ones of said coupling elements, and a connecting element interconnecting the gears so that the drive arrangement is operative to transmit drive to the individual gears through the connecting element so as to provide said synchronised movement.

21. A frame system according to claim 20, wherein each gear includes a plurality of teeth disposed on its outer periphery, and the connecting element is a timing belt which is operative to engage the teeth of said individual gears so as to drive the gears in the synchronised movement.

22. A frame system according to claim 20 or 21, wherein the gears are mounted on a sub frame to form a gear block, said sub frame determining the spacing between individual gears and wherein the gear block is operative to be connected to said frame member.

23. A frame system according to claim 22, wherein said frame member is generally channel shaped having a web member and opposing flanges which extend outwardly from said web member, wherein said sub frame is operative to engage said flanges to connect to said frame member.

24. A frame system according to claim 23, wherein said sub frame includes opposite edges which interfit with the edge surfaces of said respective flanges to lock said sub frame to said frame member.

25. A frame system according to claim 24, wherein said sub frame includes a main housing which includes said gears, and an outer raised portion which includes said opposite edges which interfit with said flanges of said frame member.

26. A frame system according to any one of claims 19 to 25, wherein the connecting elements are in the form of drive shafts which project outwardly from said frame member.

27. A louvre system substantially as herein described with reference to the accompanying drawings.

28. A frame system for a louvre system substantially as herein described with reference to the accompanying drawings.
